(19) United States
(12) Patent Application Publication
(10) Pub. No.: US 2015/0142631 A1
(43) Pub. Date: May 21, 2015

(54) METHOD AND SYSTEM FOR UNDERPERFORMING CREDIT ANALYSIS

(71) Applicant: Karl Falk, Monument, CO (US)

(72) Inventor: Karl Falk, Monument, CO (US)

(73) Assignee: SHORTSAVE, INC., Monument, CO (US)

(21) Appl. No.: 14/546,792

(22) Filed: Nov. 18, 2014

Related U.S. Application Data
(60) Provisional application No. 61/906,713, filed on Nov. 20, 2013.

(51) Int. Cl. G06Q 40/02

(52) U.S. Cl. CPC G06Q 40/02
USPC 705/35

(57) ABSTRACT

Non-performing home loans can be resolved by objectively matching resolution criteria set forth by a note holder regarding various resolution paths and data provided by the borrower reflecting their current economical state and desired outcome. The non-performing loan resolution system of the present invention determines whether specific loan resolution paths are acceptable based on predetermined criteria set forth by the note holder and data provided by the borrower. Once a resolution path is deemed acceptable, the data is validated and the resolution of the loan completed.

### RELATED APPLICATION

The present application relates to and claims the benefit of priority to U.S. Provisional Patent Application No. 61/906,713 filed 20 Nov. 2013, which is hereby incorporated by reference in its entirety for all purposes as if fully set forth herein.

### BACKGROUND OF THE INVENTION

1. Field of the Invention

Embodiments of the present invention relate, in general, to loan performance analysis and more particularly to the analysis of resolution options of non-performing loans

2. Relevant Background

When a borrower can no longer afford the payments on a loan they agreed to pay they are in “default”. When a borrower is in default the loan becomes non-performing, a non-performing loan (NPL). When loans become NPLs, banks and servicers do not receive revenue, fees, etc. from that income source. When this happens, it is typically in the bank/servicer's best interest to get the loan re-performing or settled (where the borrower can make payments again or sell property to pay off the loan), as quickly as possible. This process of the bank working through a solution with the borrower is called “loss mitigation,” where the lender mitigates the potential loss they might incur if the asset associated with the NPL were foreclosed on or repossessed.

The current process for a defaulted borrower to follow with their lender is very time, paperwork and process intensive. Banks provide defaulted borrowers with a paperwork package that has to be printed, filled out, and faxed or mailed back to the lender. Banks typically provide this package on their website and/or mail this to the borrower. This is a generic package with generic questions regardless of the type of loan or the borrower's situation. Banks will typically ask a seller to fill out a “loan mod request” package if they want to get a loan modification, or fill out a “sale” package if they want to sell their property either via a short sale or transfer the property via a deed in lieu of foreclosure transaction. Today, a borrower has little advantage to submitting a short sale package to a lender before they have an offer contract and HUD1 settlement statement on their house. Such data is typically outdated once they do get an offer on their house and they have to resubmit the same package again. This is because currently the lender cannot make a decision to short sale the property without knowing what is being offered to them (the payoff).

The process of a borrower being asked to fill out paperwork and fax back to a lender is very difficult for a borrower because they often lack the appropriate technology to do so, or lack the physical or mental ability to fill out the requested paperwork on their own. Loss mitigation is traditionally centralized for larger lenders and a borrower rarely receives face-to-face help regarding their request for a pre-foreclosure workout solution. During this process, the borrower is prone to make mistakes, fill out documents incorrectly, or overlook sending all of the requested documentation. This adds to the frustration for both the borrower and the lender, and only delays the process of loss mitigation.

Even before the borrower decides what they want to do regarding their NPL, there are many delays due to a borrower's inability to make a decision. Many borrowers are embarrassed by their situation, and many go online seeking quick answers. They are typically bombarded with ads and links for e-books, etc. Borrowers seek quick answers, but to get actual answers involves calling and talking with a debt collector, and by definition, that debt collection relationship is adversarial. This situation pushes many borrowers away from taking action as quickly as they could, or even taking action at all. But even when they do call their lender/debt collector, answers are not quick.

The biggest “pain point” for a borrower with regards to getting quick resolution or even relatively quick answers is the loss mitigation process which must be followed per today's standards. The process for a borrower to request and receive approval for a loan modification, short sale or deed in lieu of foreclosure is so delayed because every transaction must be processed, regardless if it is going to be approved or not. This forces the lender that processes these transactions to hire a staff that can process all of these package requests that come in. This is similar to a lender underwriting every loan application to its fullest without pre-qualifying that person for the loan they are requesting. This puts a labor overhead strain on the lender. Even if they hired one person for every file that came in, a percentage of those labor hours would be spent on files that would never close. A servicer is poised with the problem of optimizing file performance with effectiveness of file per person ratios. Even in a situation of one person processing each file, and only one file at a time, a lender runs into subjectivity and human error issues.

This problem of untimely responses by the lender to the borrower has become so grave that the U.S. government, specifically the Consumer Financial Protection Bureau (CFPB), created new regulations in 2014 which aimed to set standards and timeframes for how and how long lenders have to respond to the problems outlined in this position statement. Effectively and efficiently processing pre-foreclosure solutions where loans are against assets is a well-documented problem that even the U.S. Government has recognized. Lenders are now being fined millions of dollars for not meeting these new standards.

This default industry is plagued by one inherent problem: it is too reliant on people, paperwork, and processes that are forty years old. Paperwork leads to errors and misinterpretations. Paperwork can be lost, both physically and electronically after it is faxed or otherwise delivered to a lender or from a lender to a borrower. Using people leads to subjectivity and errors in delivering accurate and effective answers in a timely manner. The economics of the lending business precludes lenders from hiring enough people so they have one person working on only one file, but even if that were the case, there are still subjectivity and human errors to deal with. The prominent culprit of timely responses is requiring human processing for every request, regardless of that file's ability to close or be approved. These and other deficiencies of the current lending system are addressed by one or more embodiments of the present invention.

Additional advantages and novel features of this invention shall be set forth in part within the description that follows. These features may also become apparent to those skilled in the art upon examination of the following specifications, or may be learned by the practice of the invention. The advantages of the invention may be realized and attained by means of the instrumentalities, combinations, compositions, and methods particularly pointed out in the appended claims.

### SUMMARY OF THE INVENTION

A system, and associated methodology, for resolving non-performing home loans includes objectively matching criteria set forth by a note holder regarding various resolution paths and data provided by the borrower as to their current economical state and desired outcome. The non-performing loan resolution system of the present invention determines whether specific loan resolution paths are acceptable based on predetermined criteria set forth by the note holder and data provided by the borrower. Once a resolution path is deemed acceptable, the data is validated, and the resolution of the loan is completed.

One embodiment of the present invention includes a processor-implemented method for assessing requests to resolve non-performing real estate loans. The method includes a processor receiving a request for resolution of a non-performing loan by a homeowner or borrower. The system seeks, and the request includes, data such as personal information, a desired outcome of the loan resolution process, current income and expenses, asset data, and existing loan information. In some instances, the note holder can preload information and known data regarding the property into the system.

The method also includes a processor receiving a set of acceptance criteria from the note holder. The acceptance criteria can include an acceptable interest rate or range of rate, term information, a range of acceptable payments, and various acceptable loan types. Then, the processor executes an algorithmic analysis and compares the request and data provided by the borrower to the set of acceptance criteria established by the note holder. Responsive to the request meeting the set of acceptance criteria, the request is associated with an acceptance identifier. Thereafter, the data provided by the borrower, and the data identified by the note holder, is validated and the resolution path executed. For example, if the desired path is a loan modification, and the data provided by the borrower meets the acceptance criteria for a loan modification, the modification can be approved, then data validated and the new loan executed.

Another feature of the present invention's method for assessing requests to resolve NPLs is that the comparison of data associated with the request to resolve an NPL determines whether a modified loan value based on the request specified data exceeds a minimum loan value based on the set of acceptance criteria. Once the minimum threshold is exceeded, the transaction is approved. If the threshold is not exceeded, the request is denied. In another version of the present invention, an analysis of a request to resolve an NPL uses the net present value of the modified loan's value, as well the net present value of the minimum loan value presented by the note holder. In doing so, the time value of money is considered, as is the current state of the loan and market.

According to another embodiment of the present invention, when the minimum loan value set forth by the note holder exceeds the modified loan value based on data provided by the homeowner, the request to resolve the NPL is denied and associated with a denial identifier. Upon receiving a notification of denial, the homeowner can consider proposing a different resolution path such as deed-in-lieu of foreclosure transaction or a short sale of the property. Alternatively, the homeowner can reconsider the data that was submitted for the loan modification request and reattempt that resolution path but with a different set of initial conditions. For example, the homeowner may propose a larger initial or “good faith payment” if the first attempt for a loan modification was denied. In another case the homeowner may consider additional income from a co-signer to help qualify.

Another aspect of the present invention is to consider alternative resolution paths. When a borrower initiates a request for resolution of a NPL by seeking to modify the existing loan, the data provided may not be sufficient to meet the note holder's minimum acceptance criteria. However, a NPL may still be resolved by using an alternative resolution path. The present invention, by reaching the determination that a request does not meet the note holder's acceptance criteria for a particular resolution path, considers whether the NPL can be resolved using a different resolution path such as a short sale or the transfer of the ownership interest in the property via a deed-in-lieu of foreclosure transaction.

Another version of the present invention is an apparatus for assessing requests to resolve non-performing real estate loans. Such an apparatus, according to one embodiment of the present invention, includes a memory and processor. In such an instance, the memory is in communication with the processor, and is configured to issue to that processor a plurality of processing instructions. These instructions, embodied as software, direct the processor to receive a request for resolution of a NPL. Then, the request specifies that the data includes personal information, a desired outcome and desired path for resolution, income and expense information, data regarding assets, and information related to the existing loan.

The processor further accepts instructions to receive a set of acceptance criteria (from the note holder) including acceptable interest rates, terms, a payment range, and type of loan. As one of reasonable skill in the relevant art will appreciate, the acceptance criterion sets forth a set of fundamental components that craft an acceptance analysis and determination. For example, it may be acceptable for the note holder to have a lower interest rate if the term of a loan modification is extended or contracted. Once the data from the borrower and acceptance criteria from the note holder is collected, the processor receives another set of instructions to compare the request to the set of acceptance criteria and responsive to the request meeting the set of acceptance criteria, the request is associated with an acceptance identifier.

The aforementioned apparatus, according to one embodiment of the present invention, determines whether a modified loan value, based on data supplied by the borrower, exceeds a minimum loan value crafted from the set of acceptance criteria. When the value of the modified loan exceeds the minimum loan value set forth in the acceptance criteria, the resolution path is accepted.

In another embodiment of the present invention, a processor-accessible medium includes code for assessing requests to resolve non-performing loans. While many of embodiments presented herein are presented with reference to real estate loans one of reasonable skill in the relevant art will appreciate that the concepts presented herein are equally applicable to other forms of non-performing loans. The medium includes a plurality of processing instructions that are issuable by a processor to receive a request for resolution of a NPL. The request includes data such as personal information, a desired outcome of the loan resolution process, income and expense information, asset data, and information regarding the existing loan. The medium also includes instructions to receive from the note holder a set of acceptance criteria including acceptable interest rates, term information, acceptable payment ranges, and various types of loans.

Also included on the medium are instructions to compare data associated with the request to the set of acceptance criteria. Also included are instructions to associate the request with an acceptance identifier when the data provided by the borrower meets the acceptance criteria set forth by the note holder. In other aspects of the present invention, the comparison of the data provided by the borrower to the set of acceptance criteria set forth by the note holder is accomplished by instructions stored on the medium and executed by a processor that compares whether a modified loan value based on the request specified data exceeds a minimum loan value based on the set of acceptance criteria.

One of reasonable skill in the relevant art will recognize that there may be a plurality of combinations of the acceptance criteria that may result in a request being accepted. The present invention considers various permutations of data supplied by the borrower and the note holder to determine whether the desired resolution path is acceptable.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 presents a high-level block diagram illustrating the relationship of one or more embodiments of the present invention with respect to a borrower, a note holder, and a loan service provider;

FIG. 2 presents a flowchart illustrating one method embodiment of the present invention for resolving a non-performing loan;

FIG. 3 illustrates a process by which a modification of a NPL can be predetermined using the system of the present invention;

FIG. 4 illustrates a process by which a NPL can, according to one embodiment of the present invention, be resolved by a short sale or a transfer of title via a deed-in-lieu of foreclosure instrument;

FIG. 5 presents a high-level block diagram depicting a system for resolution of non-preforming home loans according to one embodiment of the present invention; and,

FIG. 6 presents a high-level block diagram of a computer environment in which the present invention may be implemented.

The Figures depict embodiments of the present invention for purposes of illustration only. One skilled in the art will readily recognize from the following discussion that alternative embodiments of the structures and methods illustrated herein may be employed without departing from the principles of the invention described herein.

### DESCRIPTION OF THE INVENTION

Disclosed hereafter by way of example is a system and associated methodology for resolving non-performing real estate loans. Embodiments of the present invention are hereafter described in detail with reference to the accompanying Figures. Although the invention has been described and illustrated with a certain degree of particularity, it is understood that the present disclosure has been made only by way of example and that those skilled in the art can resort to numerous changes in the combination and arrangement of parts without departing from the spirit and scope of the invention.

The present invention presents a new objective process by which non-performing loans and similar transactions can be reviewed, analyzed, and approved before being submitted to a loan processor or similar individual. Placing the approval process before examination of relevant documents alters the loan processor's role from determining whether a non-preforming loan warrants reconsideration and what those terms would be to simply validating one or more assumptions that has driven the system to conclude that a particular non-performing loan can be resolved with the provided terms.

The following description with reference to the accompanying drawings is provided to assist in a comprehensive understanding of exemplary embodiments of the present invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

By the term “substantially,” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Like numbers refer to like elements throughout. In the figures, the sizes of certain lines, layers, components, elements or features may be exaggerated for clarity.

The terminology used herein is for the purpose of describing particular embodiments only, and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will also be understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

For the purpose of the present invention, a “non-performing loan” (sometimes referred to herein as “NPL”) is a secured loan in which the borrower is unable to pay the required monthly payment. While the borrower is likely in breach of the agreement between the borrower and the note holder, and the note holder may initiate a foreclosure action, such legal causes of action are costly and time consuming. Moreover, though the borrower may be making some payment toward the note, the note is nonetheless not producing the income as designed. Thus, the note (loan) is underperforming from the perspective of the note holder and not providing a desirable return on investment. Thus, and as one of reasonable skill in the art will appreciate, a non-performing loan is one in which the terms of the note are not being met, but the loan itself is not necessarily without value.

A “note holder” is the institution which owns the promissory note and possesses the right to foreclose on the property should the loan go into default. In many cases, the note holder is a large institution that purchases and sells blocks of notes as a trading commodity. Therefore, from the note holder's perspective, a note is a financial instrument on which to base a return on an investment. For example, if a note for a house possessed a positive net present value the note holder would consider it a valuable investment. Accordingly, a modified note that possesses a positive net present value is better than a note that is non-performing.

In finance, net present value (NPV) or net present worth (NPW) of a time series of cash flows, both incoming and outgoing, is defined as the sum of the present values (PVs) of the individual cash flows of the same entity. Since the value of $1 is generally more today that it is at some time in the future, the present value of a $1/month cash flow for one year is less than $12. The difference in these two amounts is referred to as the “discount rate.” In the case when all future cash flows are incoming (such as loan payments and principal of a bond) and the only outflow of cash is the purchase price, the NPV is simply the PV of future cash flows minus the purchase price (which is its own PV). NPV is a central tool in discounted cash flow (DCF) analysis and is a standard method for using the time value of money to appraise long-term projects. Used for capital budgeting and widely used throughout economics, finance, and accounting, it measures the excess or shortfall of cash flows, in present value terms, above the cost of funds.

The term “borrower,” as used in the present invention, is an individual or entity that is the indebted entity of a secured credit transaction. In such a loan document, the borrower is responsible for adhering to the payment terms of the note and is otherwise in breach of the agreement. In extreme cases, a breach can lead to collection efforts including foreclosure on the security interest in the loan. With respect to real estate transactions, a failure to pay the agreed upon payments can result in foreclosure of the property by the note holder.

Many secured transactions also involve a loan servicing agent or loan servicer. These institutions, for a fee, carry out the mechanics of initiating and maintaining a loan as well as collecting the monthly premiums. They also manage escrow accounts and other related transactions that must take place for the loan to remain in good standing. Traditionally, loans are originated by the loan servicer and look to a note holder to back or fund the loan. In some cases, the holder of the loan may change several times while the servicer remains the same. In some instances the note holder may stay the same while servicing rights are bought and sold causing the servicing agent to change. In other instances, the note holder may elect to use a different loan-servicing agent while retaining ownership of the loan. The loan servicer is typically the institution to which a monthly payment is placed, and with whom most borrowers regularly interact.

While many non-performing loans are modified or reissued with different terms, another alternative considered by the present invention is the transference of the property from the borrower to the note holder via a deed-in-lieu of foreclosure transaction. Such a means of resolving a non-performing loan provides the deed of the property to the note holder and relieves the borrower of any further obligation. In such an instance, the borrower gives up their ownership interest and right to occupy the property in exchange for being relieved of further obligations under the loan.

Another option is to short sell the house. A short sale is when the house is sold to a third party for less than the face value of the loan. These loans are deemed “underwater.” In such an instance, the note holder may forgive any outstanding difference between the sale price and the existing loan based on the assumption that the payoff possess better value than other alternatives and the forgiven sum is less than the cost of attempting to foreclose on a property.

As one of reasonable skill in the relevant art will appreciate, foreclosure of real estate is costly and time consuming. There are numerous regulatory and legal considerations to address when a note holder forecloses on an individual's primary residence. It is also costly for a note holder to maintain a residence that is unoccupied so that it may be sold later. Accordingly, it is often in the best interest of the note holder to revise or modify a note to preclude such action if the revised loan documents retain some degree of value for the note holder.

The present invention provides a means by which to collect readily available data and arrive at an objective decision regarding whether a non-performing loan can be resolved short of foreclosure. Included in the description are flowcharts depicting examples of the methodology that may be used to determine whether a non-performing loan can be resolved. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve the manipulation of information elements. Typically, but not necessarily, such elements may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” “words”, or the like. These specific words, however, are merely convenient labels and are to be associated with appropriate information elements.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, or display information.

Upon reading this disclosure, those of skill in the art will appreciate still additional alternative structural and functional designs for a system and a process for resolution of a non-performing loan through the disclosed principles herein. Thus, while particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation, and details of the method and apparatus disclosed herein without departing from the spirit and scope defined in the appended claims.

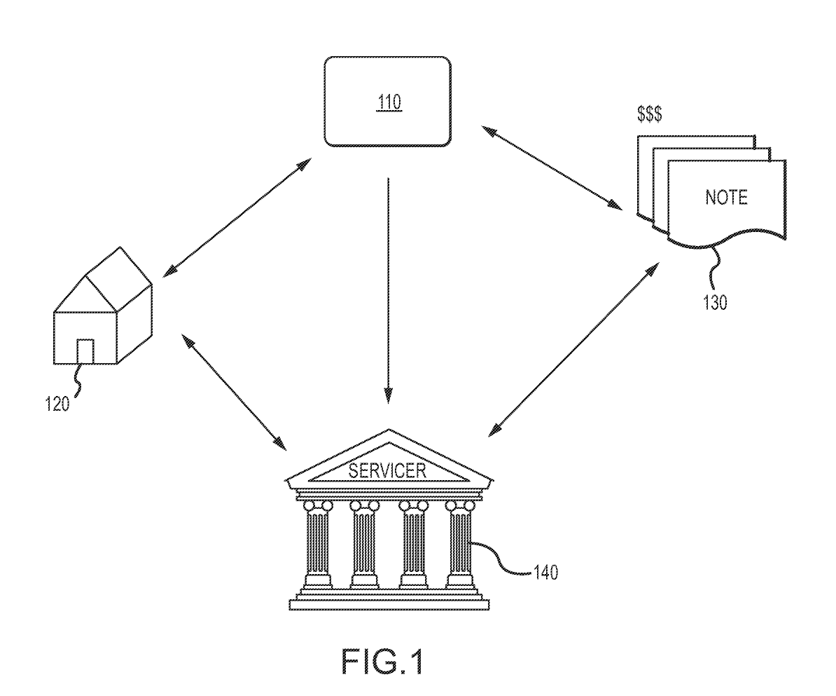

FIG. 1 presents a high-level block diagram illustrating the relationship of one or more embodiments of the present invention with respect to a borrower, a note holder, and a loan service provider. As previously discussed, traditionally a loan-servicing agent 140 is interposed between a borrower 120 and a note holder 130. In many cases, the agent 140 receives and vets an initial loan application based on its understanding of the financial markets. Upon gaining adequate information, the servicing agent will seek approval or funding from the note holder 130 and thereafter process the necessary paper work to close the transaction. In the instance of a non-performing loan, the loan-servicing agent 140 can impede the transfer of information between the note holder 130 and the borrower 120. For example, a borrower 120 may realize an obligation to a non-preforming loan is beyond their capability yet desires to work with the note holder 130 to arrive at terms so as to remain in the property. Often times the loan servicer 140 can impede or block such a process due to inherent inefficiencies and lack of authority to act. Moreover, the loan servicer acts from the position of collecting information to determine the status of a loan and presenting a viable option to the note holder. By contrast, the present invention approaches the problem from one of a known solution or set of acceptance standards. According to one embodiment of the present invention, a non-performing loan resolution system 110 communicatively couples the borrower 120 directly with the note holder 130 to determine, based on information quickly supplied by the borrower 120 and the note holder 130, whether the non-performing loan can be resolved. Once a determination is made that the non-preforming loan can be resolved, terms are identified and the loan servicer, in one embodiment of the present invention, works to validate the data supporting the approval. Lacking any discovery that invalidates the position forwarded by the borrower and note holder, the non-performing loan resolution is closed.

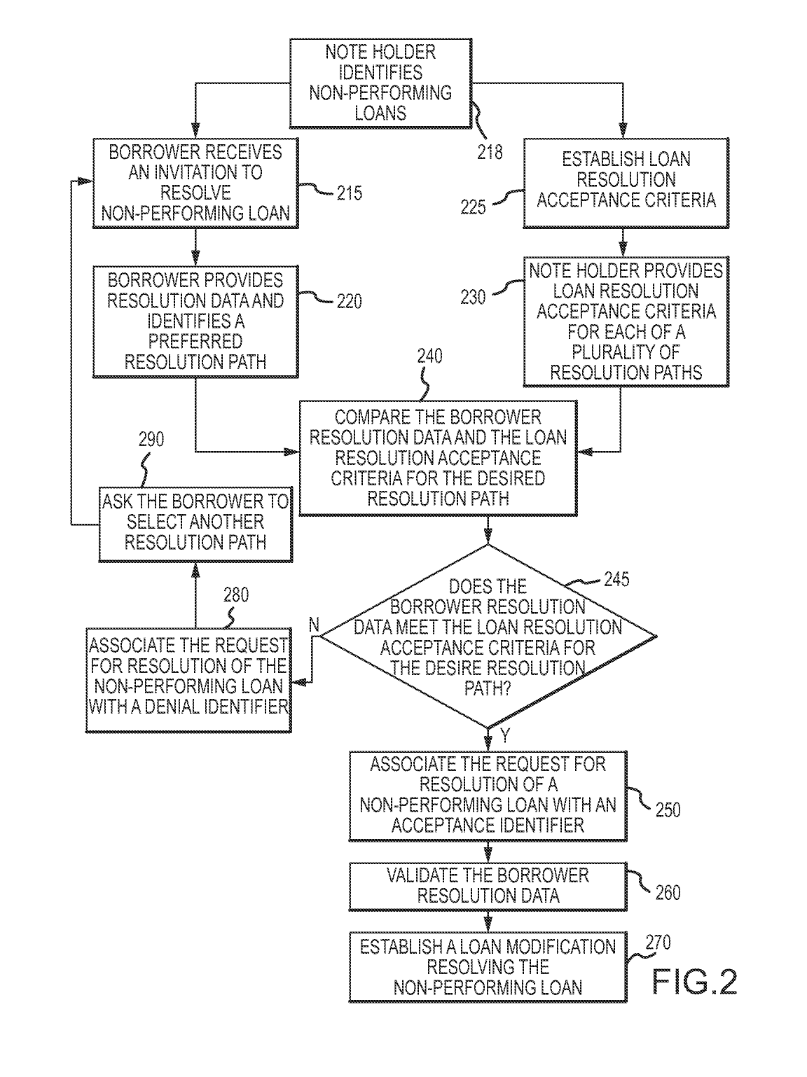

The present invention significantly modifies the existing process by which non-performing loans are analyzed and thereafter modified without or prior to interaction with a loan servicer. FIG. 2 presents a flowchart illustrating one method embodiment of the present invention for resolving a non-performing loan. The process begins with the identification 210 by the note holder of one more non-performing loans. Recall that the note holder likely possesses hundreds or thousands of loans. A portion of those loans may be identified as non-performing loans. Each note holder likely possesses different criteria by which to determine which loans are and are not considered non-performing. However, once identified as a non-performing loan, it is in the best interest of the note holder to ascertain whether the non-performing nature of the loan can be resolved. In most instances, non-preforming loans can be resolved though a loan modification, a short sale, or transference of the security interest (property) through a deed-in-lieu of foreclosure process. By achieving one of these processes, both the note holder and the borrower can arrive at a mutually agreeable solution in a timely and cost effective manner.

With one or more non-preforming loans identified, two components are necessary before a determination can be made with respect to loan resolution. The note holder first provides acceptable loan resolution criteria 225. For each loan resolution path (loan modification, short sale, or deed-in-lieu), the note holder conveys what minimum criteria must be meet for it to arrive at an acceptable solution. While the compilation of such criteria is proprietary to each note holder, it is nonetheless finite, and can be used as a benchmark by which to evaluate each non-performing loan.

This base line criteria is thereafter associated 230 with known non-performing loans given the information that the note holder possess. For example, the note holder is aware of, among other things, the current terms of the loan as well as the property location, state of the property, and the amount that the note holder has invested. However, this data alone is insufficient to make a determination regarding resolution of a non-performing loan. The inquiry also requires information from the borrower such as the borrower's intent and desired outcome.

According to one embodiment of the present invention, the borrower receives 215 an invitation to use the system of the present invention to resolve their current non-performing loan. Without interacting with a servicer or the note holder directly, the borrower can provide confidential information that enables the system to determine if a loan resolution path is available. Upon beginning the loan resolution process, the borrower is asked to provide 220 resolution data and a desired outcome. For example, the borrower is asked so submit their current gross income and expenses as well as a payment amount that they feel they can realistically provide. Moreover, the system inquires as to whether the borrower/homeowner desires to remain in the home (if it is a residence) or whether they would prefer to sell the property and move on.

Using data provided by the borrower combined with the data possessed by the note holder regarding the current loan (collectively, resolution data), the system of the present invention compares 240 the resolution data against the existing loan resolution acceptance criteria for the path desired by the borrower. The analysis implements several algorithms and financial analysis techniques to assess whether the current status and intent of the borrower meets the requirements set forth by the note holder.

Significantly, the determination of acceptance of the proposed non-performing loan resolution is made prior to validation of pertinent data. Rather, for the path selected, certain assumptions are made with respect to the data provided and, assuming these assumptions are valid, the resolution of the non-performing loan is approved. Returning to the flowchart shown in FIG. 2, an inquiry 245 is thus made whether the resolution data meets the loan resolution acceptance criteria for the desired resolution path.

When the response to the inquiry is “yes,” the request is associated 250 with an acceptance identifier. The borrower is notified that given the stated set of facts and their desired path to resolve their current non-performing loan, that the note holder, in principle, agrees, and that upon validation of their statement, the transaction should proceed. Once the borrower accepts the terms of the proposed resolution path, the data submitted by the borrower is validated 260. In some instances, the validation effort can be accomplished by the current loan servicer or in other instances by an independent third party. Unlike the current loan resolution process in which loan servicing agents must gather and interpret information with no real sense of whether the non-performing loan can be resolved, according to the present invention, the loan resolution path has been determined and approved. According to the present invention, use of this system will transform the role of loan services from analyzing to validating. And once the data submitted by the borrower is validated, the new loan can be closed 270.

As one of reasonable skill in the relevant art will appreciate, not all non-performing loans can be resolved in the manner desired by the borrower. For example, a note holder may find that a reduced mortgage payment is preferable to gaining ownership of the property through foreclosure. However, there will be an economical limit of how low of a payment the note holder will accept as opposed to allowing the borrower to short sell the house or accepting the deed and initiating a sale of the property themselves.

When the response to the inquiry of whether the resolution data and proposed option (path) meets note holder's loan resolution acceptance criteria is “no,” the request is associated 280 with a denial identifier. In some instances, the basis for the denial is provided to the borrower to see if the borrower can adjust their position. For example, perhaps the borrower would consider a slightly larger payment if such an increase might mean the difference between staying in the home or being forced to sell the home. In one embodiment of the present invention, the system asks 290 the borrower whether they would like to consider other resolution paths such as a short sale.

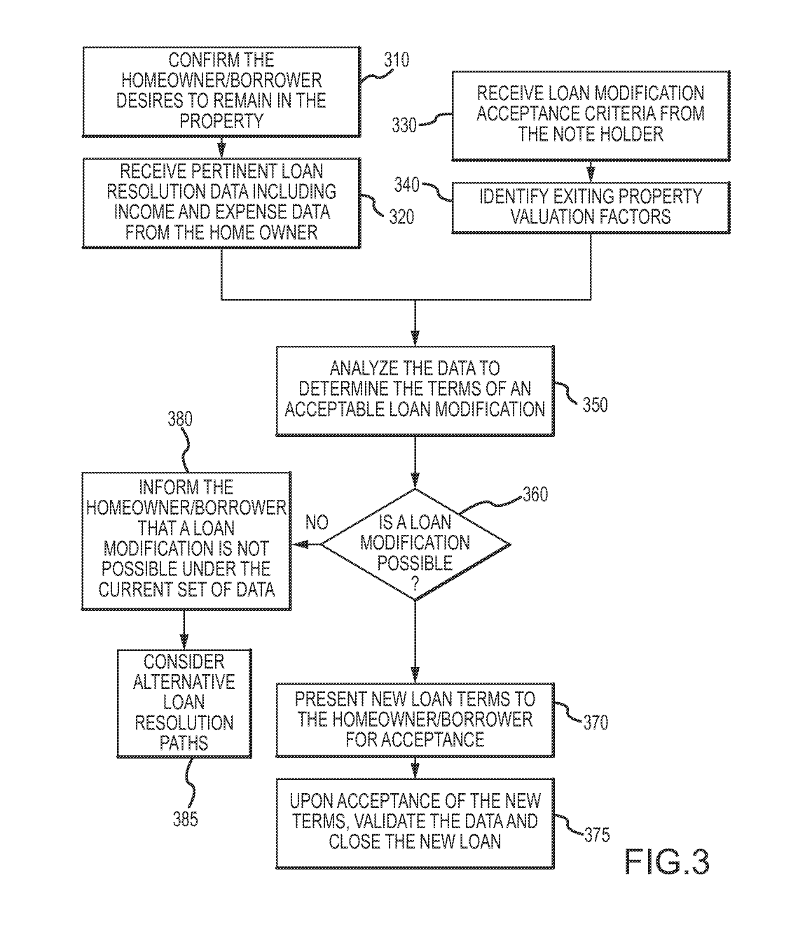

FIG. 3 illustrates a process by which a modification of a non-performing loan can be predetermined using the system of the present invention. As described above, the process begins 310 with the borrower confirming that they would like to remain in the home. The system then begins to determine if such a path is possible given the note holder's predetermined criteria. The system asks for and receives 320 from the borrower data such as gross income, total expenses, credit card payments, other loan payments, child support, alimony or other court ordered payments, insurance, health payments, home owners association dues, and other expenses that would reduce a borrower's disposable income. The system may also inquire if the borrower can provide a good faith or lump sum amount of money to be applied to the balance of the loan. Lastly, the system inquires what the borrower feels they can reasonably afford to pay in exchange for the ability to stay in the house.

Once this information is obtained from the borrower, loan modification criteria are retrieved 330 from the note holder. One of reasonable skill in the relevant art will appreciate that a plurality of factors may be considered by the note holder before agreeing to modify a loan. No one factor may be independent. This means that for each scenario, multiple factors must be considered to arrive at an approval decision. Nonetheless, the decision process is objective rather than subjective.

Factors that may be considered include the property address, general location within a community, tax burden, the need for hazard insurance, the type of the original loan (fixed vs. ARM) and the nature or type of the note holder. The condition of the property is considered, as is its current market value. Other factors to consider include the original loan amount and the current balance, the date of the loan, and the current and prior interest rate. The number of months past due are considered, as well as the stated reason for default and any delinquency classification. Delinquent interest, delinquent taxes, and any forbearance amounts are also considered. These and other factors are analytically deliberated 350 to arrive at a determination 360 of whether the existing loan can be modified. Note that the borrower did not provide a suggested interest rate or term, nor did the note holder specify the type that may be offered. For example, the income and expense information provided by the borrower, along with the suggested good faith payment estimate may be sufficient to fall within a longer-term loan or one that possesses a balloon payment at a later date.

The note holder's criteria may also be flexible. It may indicate, for example, that for certain loan types it would be willing to accept a longer term at a lower interest rate. The present invention considers various options to arrive at a mutually acceptable arrangement. When such a condition has been found, the terms of the modified loan are presented 370 to the borrower for acceptance. Once accepted, the information provided by the borrower is validated, loan documents prepared, and the loan closed. Note that acceptance by the note holder is not necessary as the note holder has established predetermined criteria by which it would accept a modified loan. If the new loan meets the criteria, then the modification is automatically accepted.

The process efficiently and objectively explores a plurality of options to determine if a loan modification exits within both the homeowner's and the note holder's criteria. In the event that no solution can be found the borrower is informed that given the current set of data a loan modification is not possible, and inquires 380 if the borrower would like to consider a short sale of the home or the transfer of the property to the note holder by signing a deed-in-lieu of foreclosure document.

While many homeowners want to continue to reside within their home, some would rather sell the home or turn the home over to the note holder and move on. Others realize after attempting to modify their loans that their options are limited and to preclude going through a long and expensive foreclosure process they may wish to consider either a short sale or the transfer of the property to the note holder via a legal document known as a deed-in-lieu (“DIL”) of a foreclosure.

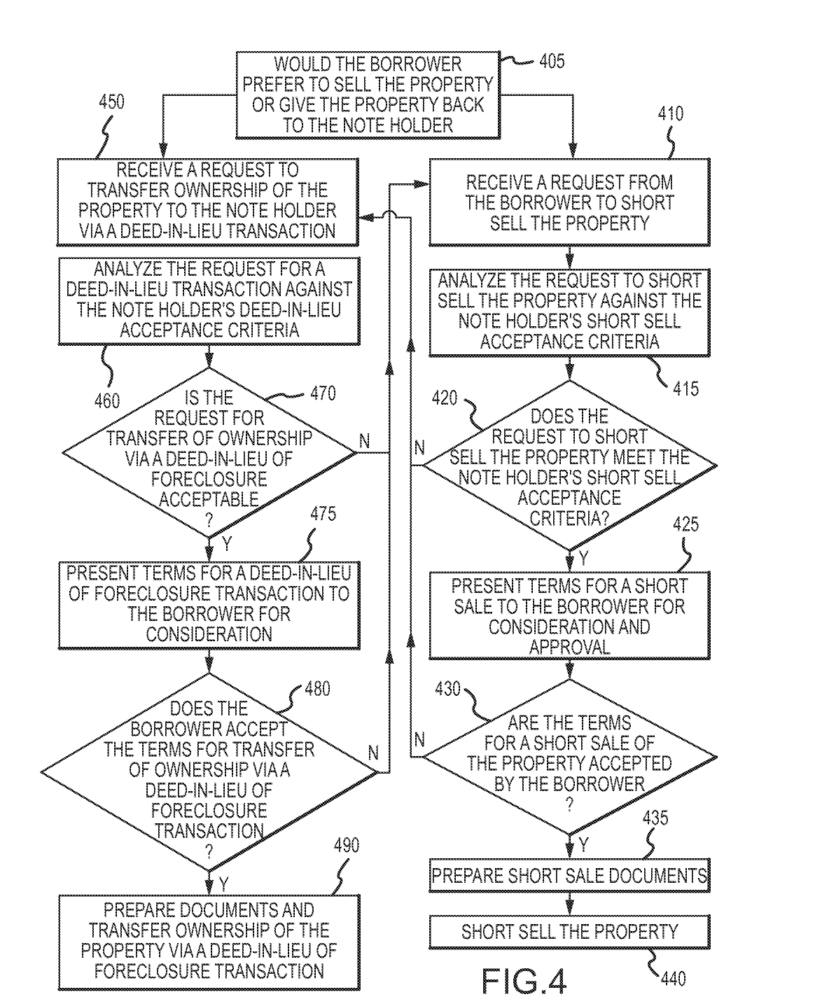

FIG. 4 presents a flowchart of one method embodiment according to the present invention for initiating a short sale of the property or transferring ownership of the property via a DIL of foreclosure document. The process begin with an inquiry as to whether 405 the borrower would prefer to short sell the house or transfer the house to the note holder through a DIL of foreclosure document.

In the instance in which the borrower prefers to sell the property, the borrower summits a request 410 to sell the property for an amount less than the current unpaid balance of the loan. As with the request to modify the existing loan, the request to short sell a property is analyzed 415 against the note holder's predetermined criteria for approving a short sale.

According to one embodiment of the present invention, the analysis to approve or disapprove a short sale is objective based on several factors. The analysis includes considering whether the payoff of the current loan is greater or smaller than the short sale net present value. Moreover, the present invention based on criteria set forth by the note holder considers if a short sale net present value is greater than the foreclosure net present value. These net present value tests are factored against finite levels of closing costs, commissions, and contract prices to arrive at a decision of whether a short sale option is acceptable. This analysis, according to one embodiment of the present invention, is objective, not subjective and can be accomplished via algorithms rather than human interaction and interpretation.

Accordingly, upon conducting the analysis, an inquiry is made 420 whether the request for a short sale, based on the inputs from the borrower and the criteria set forth by the note holder, is acceptable. When a short sale meets the note holder's acceptance criteria, the terms of such a sale are presented 425 to the borrower for review. If the borrower accepts the short sale terms 430, the data submitted by the borrower is validated and the sale of the home is advanced to closing 435. In some instances, even a short sale of a property may provide the homeowner with a cash return. This is likely because the note holder recognizes that the short sale prevents the note holder from initiating (and paying) for a foreclosure process and thus it is in the best interest of both parties to retire the existing loan and move on.

In the instance in which the request for short sale is deemed unacceptable or the homeowner rejects the terms for short sale presented by the note holder, the borrower may still consider transferring the ownership interest in the property to the note holder via a deed-in-lieu of foreclosure instrument. Either as a result of being denied the opportunity to sell the home, or when the borrower simply prefers to turn over the property, the first step in initiating a deed-in-lieu of foreclosure transaction is to submit a request 450. This serves to determine whether the current state of the property and associated facts meets 460 the note holder's criteria for a deed-in-lieu of foreclosure transaction. As with a loan modification and a short sale, the request for transferring property ownership in exchange for being relieved from the loan's obligations is objectively analyzed against a predetermined set of criteria set by the note holder. One facet of the present invention is to apply the same analysis process for a wide variety of borrowers and note holders. While each note holder will have different acceptance criteria and the data of each borrower will differ, one advantage of the present invention is that the objective process by which approval or disapproval is achieved is consistent, efficient, and quick.

If the request to transfer the property to the note holder is determined unacceptable 470, a negative answer may be issued. In such an instance, the homeowner may, if not yet considered, elect to short sell 410 their house. However, if the request to transfer ownership of the home to the note holder using a deed-in-lieu of foreclosure instrument is approved, the terms of such a transaction is presented 480 to the homeowner for consideration and approval. If the terms are acceptable to the homeowner, documents are prepared and the transaction proceeds to closing. Should the terms of the transfer not be acceptable to the homeowner, the borrower can still consider a short sale or a loan modification. In such instances the process begins anew.

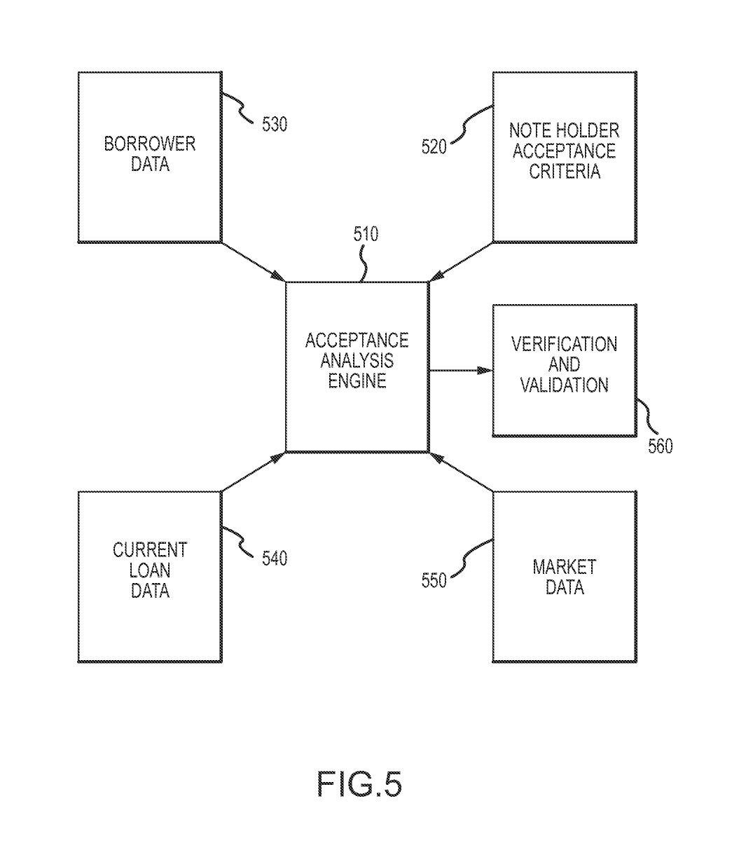

FIG. 5 presents a high-level block diagram depicting a system for resolution of non-preforming home loans according to one embodiment of the present invention. It will also be understood by those familiar with the art that the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

As shown in FIG. 5, borrower data 530 reflecting the borrower's current state, as well as a set of acceptance criteria 520 provided by the note holder is conveyed to an acceptance analysis engine 510. The engine compares the data provided by the borrower against the criteria set forth by the note holder in view of market data 540 and data reflecting the exiting loan conditions 540. Upon acceptance of the proposed course of action the data is verified and validated 560. In a preferred embodiment, the present invention can be implemented in software. Software programming code that embodies the present invention is typically accessed by a microprocessor from long-term, persistent storage media of some type, such as a flash drive or hard drive. The software programming code may be embodied on any of a variety of known media for use with a data processing system, such as a diskette, hard drive, CD-ROM, or the like. The code may be distributed on such media, or may be distributed from the memory or storage of one computer system over a network of some type to other computer systems for use by such other systems. Alternatively, the programming code may be embodied in the memory of the device and accessed by a microprocessor using an internal bus. The techniques and methods for embodying software programming code in memory, on physical media, and/or distributing software code via networks are well-known and will not be further discussed herein.

Generally, program modules include routines, programs, objects, components, data structures, and the like that perform particular tasks or implement particular abstract data types. Moreover, those skilled in the art will appreciate that the invention can be practiced with other computer system configurations, including hand-held devices, multi-processor systems, microprocessor-based or programmable consumer electronics, network PCs, minicomputers, mainframe computers, and the like.

The invention may also be practiced in distributed computing environments where tasks are performed by remote processing devices that are linked through a communications network. In a distributed computing environment, program modules may be located in both local and remote memory storage devices.

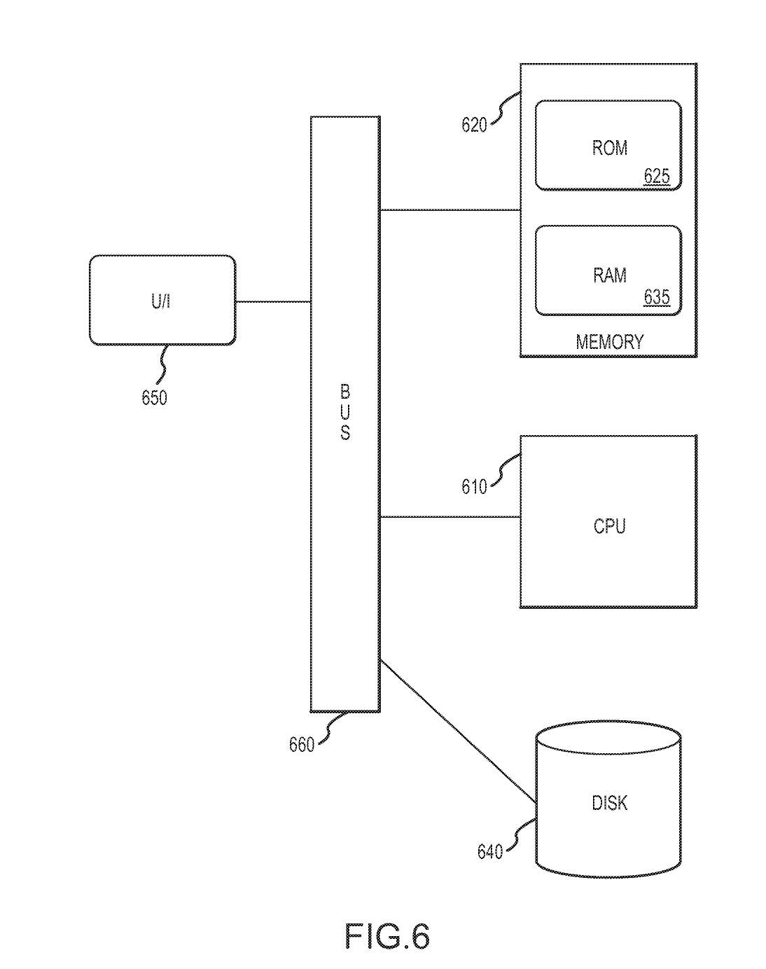

An exemplary system for implementing the invention as shown in FIG. 6 includes a general purpose computing device such as the form of a conventional personal computer, a personal communication device or the like, including a processing unit 610, a system memory 620, and a system bus 660 that couples various system components, including the system memory 620 to the processing unit 610. The system bus 660 may be any of several types of bus structures including a memory bus or memory controller, a peripheral bus, and a local bus using any of a variety of bus architectures. The system memory generally includes read-only memory (ROM) 625 and random access memory (RAM) 635. A basic input/output system (BIOS), containing the basic routines that help to transfer information between elements within the personal computer, such as during start-up, is stored in ROM 625. The personal computer may further include a hard disk drive for reading from and writing to a hard disk 640, a magnetic disk drive for reading from or writing to a removable magnetic disk and a user interface 650. The hard disk drive and magnetic disk drive are connected to the system bus by a hard disk drive interface and a magnetic disk drive interface, respectively. The drives and their associated computer-readable media provide non-volatile storage of computer readable instructions, data structures, program modules, and other data for the personal computer. Although the exemplary environment described herein employs a hard disk and a removable magnetic disk, it should be appreciated by those skilled in the art that other types of computer readable media which can store data that is accessible by a computer may also be used in the exemplary operating environment.

An implementation of the present invention may also be executed in a Web environment, where software installation packages are downloaded using a protocol such as the HyperText Transfer Protocol (HTTP) from a Web server to one or more target computers (devices, objects) that are connected through the Internet. Alternatively, an implementation of the present invention may be executing in other non-Web networking environments (using the Internet, a corporate intranet or extranet, or any other network) where software packages are distributed for installation using techniques such as Remote Method Invocation (“RMI”) or Common Object Request Broker Architecture (“CORBA”). Configurations for the environment include a client/server network, as well as a multi-tier environment. Furthermore, it may happen that the client and server of a particular installation both reside in the same physical device, in which case a network connection is not required.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim, and whether or not it mitigates any or all of the same technical problems as confronted by the present invention. The Applicant hereby reserves the right to formulate new claims to such features and/or combinations of such features during the prosecution of the present application or of any further application derived therefrom.

I claim:

1. A processor-implemented method for assessing requests to resolve non-performing real estate loans, comprising:
receiving, by the processor, a request for resolution of a non-performing loan, the request specifying data including
personal information,
desired outcome,
income,
asset data, and
existing loan information;
receiving, by the processor, a set of acceptance criteria including
interest rate,
term,
payment, and
loan type;
comparing, by the processor, the request to the set of acceptance criteria;
responsive to the request meeting the set of acceptance criteria, associating, by the processor, the request with an acceptance identifier; and,
responsive to associating the request with the acceptance identifier, validating data specified with the request.

2. The processor-implemented method for assessing requests to resolve non-performing real estate loans according to claim 1, wherein a borrower associated with the non-performing loan issues the request.

3. The processor-implemented method for assessing requests to resolve non-performing real estate loans according to claim 1, wherein comparing includes determining whether a modified loan value based on the request specified data exceeds a minimum loan value based on the set of acceptance criteria.

4. The processor-implemented method for assessing requests to resolve non-performing real estate loans according to claim 3, wherein the modified loan value and the minimum loan value are net present values.

5. The processor-implemented method for assessing requests to resolve non-performing real estate loans according to claim 3, wherein responsive to the minimum loan value exceeding the modified loan value, associating the request with a denial identifier.

6. The processor-implemented method for assessing requests to resolve non-performing real estate loans according to claim 5, wherein responsive to associating the request with the denial identifier, further comprising, by the processor, whether the request meets deed in lieu of foreclosure criteria.

7. The processor-implemented method for assessing requests to resolve non-performing real estate loans according to claim 5, wherein responsive to associating the request with the denial identifier, further comprising, by the processor, whether the request meets foreclosure criteria.

8. The processor-implemented method for assessing requests to resolve non-performing real estate loans according to claim 3, wherein the request is associated with the acceptance identifier responsive to the modified loan value exceeding the minimum loan value.

9. An apparatus for assessing requests to resolve non-performing real estate loans, comprising:
a memory; and
a processor disposed in communication with the memory and configured to issue a plurality of processing instructions stored in the memory, wherein the processor issues instructions to:
receive a request for resolution of a non-performing loan, the request specifying data including
personal information,
desired outcome,
income,
asset data, and
existing loan information;
receive a set of acceptance criteria including
interest rate,
term,
payment, and
loan type;
compare the request to the set of acceptance criteria; and,
responsive to the request meeting the set of acceptance criteria, associate the request with an acceptance identifier.

10. The apparatus for assessing requests to resolve non-performing real estate loans according to claim 9, wherein the instructions issued by the processor for comparing includes instructions to determine whether a modified loan value based on the request specified data exceeds a minimum loan value based on the set of acceptance criteria.

11. The apparatus for assessing requests to resolve non-performing real estate loans according to claim 10, wherein the request is associated with the acceptance identifier responsive to the modified loan value exceeding the minimum loan value.

12. A processor-accessible medium for assessing requests to resolve non-performing real estate loans, comprising:
a plurality of processing instructions stored in the medium and issuable by a processor to:
receive a request for resolution of a non-performing loan, the request specifying data including
personal information,
desired outcome,
income,
asset data, and
existing loan information;
receive a set of acceptance criteria including
interest rate,
term,
payment, and
loan type;
compare the request to the set of acceptance criteria; and,
responsive to the request meeting the set of acceptance criteria, associate the request with an acceptance identifier.

13. The processor-accessible medium for assessing requests to resolve non-performing real estate loans according to claim 12, wherein the instructions for comparing includes instructions to determine whether a modified loan value based on the request specified data exceeds a minimum loan value based on the set of acceptance criteria.

14. The apparatus for assessing requests to resolve non-performing real estate loans according to claim 14, wherein the request is associated with the acceptance identifier responsive to the modified loan value exceeding the minimum loan value.
